(19) United States
(12) Patent Application Publication
(10) Pub. No.: US 2015/0239111 A1
(43) Pub. Date: Aug. 27, 2015

(54) VALVE STEM RELEASE TOOL

(71) Applicant: Energy Performance Valve Services Corp., Calgary (CA)

(72) Inventor: Anthony Michael Duxbury, Calgary (CA)

(21) Appl. No.: 14/631,752

(22) Filed: Feb. 25, 2015

Related U.S. Application Data
(60) Provisional application No. 61/944,161, filed on Feb. 25, 2014.

(51) Int. Cl. B25B 27/24; B23P 19/04

(52) U.S. Cl. CPC B25B 27/24; B23P 19/04

(57) ABSTRACT

A stem release tool for freeing stuck valves is attached to the top of the valve and provides a conduit for pressurized injection of penetrating fluid into the stem and valve seal area to free the valve. The tool is equipped with handles, which are used to rotate and free the valve. A method for using such a tool is also provided.

### FIELD OF THE INVENTION

This invention relates to a tool to free stuck valves. In particular, this invention relates to a tool to reset, open or close valves to control production, and a method of resetting, opening or closing valves using the tool.

### BACKGROUND OF THE INVENTION

The need to free stuck valves is a fact of modern energy production and other fields where valves are left at a predetermined setting for long periods of time. Often, the primary method to free a stuck valve is to apply force. However, the force used often results in distortion of the valve stem. Further, forcing the valve to open or close can damage wellheads and high-pressure natural gas facilities, some with toxic content, which can result in leaks or spills and health hazards to the valve operator.

U.S. Patent Pub. No. 2008/0263843 to Gibbs discloses a repair tool for a spring-actuated valve. The tool appears to act essentially as a lever, comprising a foot for connecting to the stuck valve, an elongated shaft and an enlarged head, which is intended to be struck with a tool such as a hammer, physically forcing the valve to move and loosen. As noted above, this can cause damage to the valve, although the orientation of the foot and the shaft are designed to lessen the chance that the impacts will cause damage.

It is therefore an object of this invention to provide a tool for use in releasing a stuck or seized valve that overcomes the foregoing difficulties.

It is a further object of the invention to provide a tool for use in releasing stuck or seized valves that is portable and simple to use.

These and other objects of the invention will be better understood by reference to the detailed description of the preferred embodiment which follows. Note that the objects referred to above are statements of what motivated the invention rather than promises. Not all of the objects are necessarily met by all embodiments of the invention described below or by the invention defined by each of the claims.

### SUMMARY OF THE INVENTION

The release tool of the present invention is easy to apply and use, requiring only minimal training on its safety features, installation and operation. The tool can be transported to the site of the stuck valve, attached and operated. The tool can be used in extreme temperatures, from the artic to the desert and at various sites from control valves in the field to industrial facilities. Skilled operators with existing machine shop and manufacturing facilities can make the system.

Although described in a particular context, the release tool of the present invention may be used anywhere there is a need to free a stuck valve, including, for example, water pumping stations, oil wells and natural gas facilities. That is, the tool may be used in any industry that uses valves, which may not be opened or closed for long periods of time, and that are therefore subject to becoming stuck in one position.

In one aspect, the invention comprises a tool for use in releasing a valve stem in a valve assembly, the tool comprising a body comprising a hollow compartment and an open end; a first handle removably attached to the body, the first handle comprising a point to engage with the valve assembly; a fill port in the body; and at least one high-pressure port in the body; wherein the fill port and the at least one high-pressure port are fluidly connected to the compartment to fill the compartment with a penetrating fluid and to pressurize the fluid within the compartment to force it towards the open end and into the valve assembly. In a further aspect, the tool may comprise a second handle, or more than two handles. The handles may be opposed to each other.

In another aspect, the invention comprises a method of freeing a valve stem in a valve assembly, comprising the steps of: providing a stem release tool, the tool comprising a body comprising a hollow compartment and an open end; a first handle removably attached to the body; a fill port in the body; and at least one high-pressure port in the body; placing the open end on the valve assembly; inserting the first handle into the body such that a point on the first handle engages the valve assembly; filling the compartment with a penetrating fluid through the fill port; pressurizing the compartment using the at least one high pressure port until the penetrating fluid penetrates the valve assembly; and applying pressure to the first handle to manipulate the valve assembly through the stem release tool until the valve stem moves. In further aspects, the tool may comprise a second handle attached to the body, the method further comprising the step of applying pressure to both of the handles.

The foregoing may cover only some of the aspects of the invention. Other aspects of the invention may be appreciated by reference to the following description of at least one preferred mode for carrying out the invention in terms of one or more examples. The following mode(s) for carrying out the invention is not a definition of the invention itself, but is only an example that embodies the inventive features of the invention.

### BRIEF DESCRIPTION OF THE DRAWINGS

At least one mode for carrying out the invention in terms of one or more examples will be described by reference to the drawings thereof in which:

FIG. 1 is a sectional view of an exemplary seized valve;

FIG. 2 is a perspective view of a stem release tool according to the invention;

FIG. 3 is a sectional view of the stem release tool of FIG. 2; and

FIG. 4 is a sectional view of the stem release tool according to the invention, installed on a seized valve as in FIG. 1.

### DETAILED DESCRIPTION OF AT LEAST ONE MODE FOR CARRYING OUT THE INVENTION IN TERMS OF EXAMPLE(S)

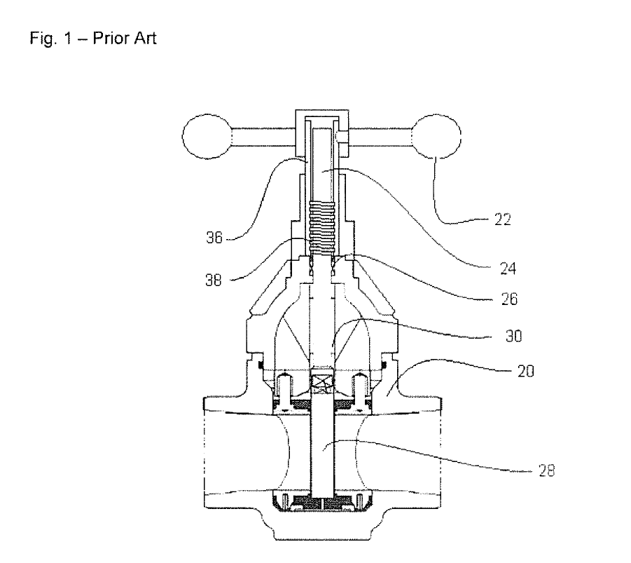

As best seen in FIG. 1, an exemplary gate valve assembly 20 comprises a control handle 22, a valve stem 24, and packing 26, which actuate a gate valve 28 and gate valve slide 30. The valve stem is actuated by a stem actuator 38, which is contained within a stem actuator sleeve 36.

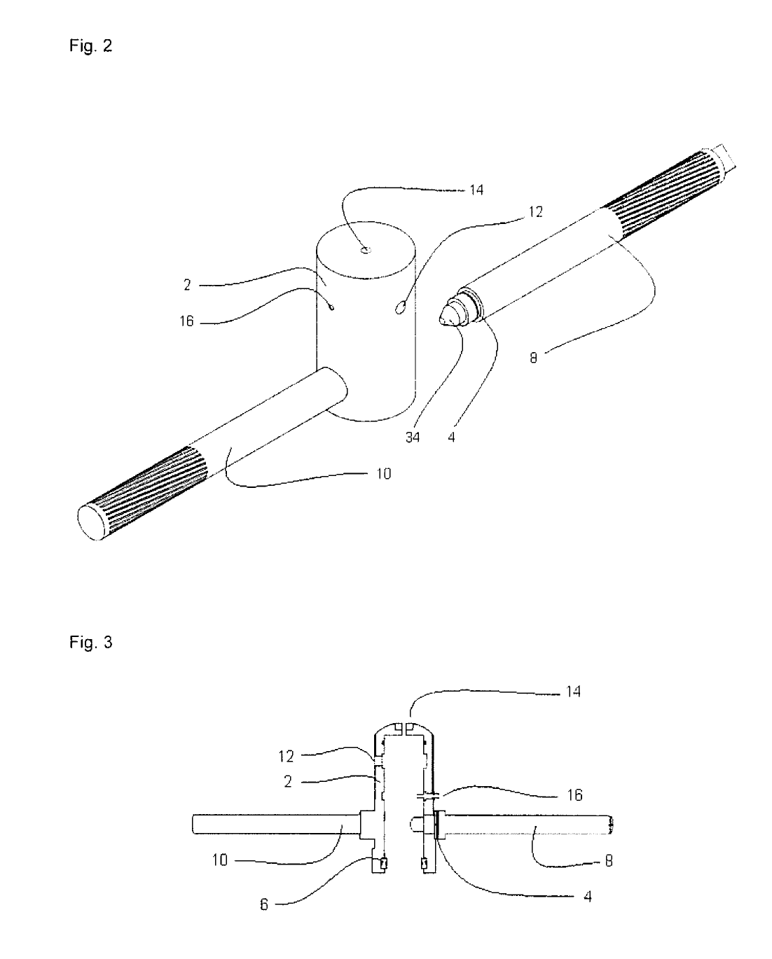

The stem release tool, best shown in FIGS. 2 and 3, comprises a body 2 having at least one, and preferably at least two, extending handles 8, 10. Handle 8 is preferably removable from the body 2, and preferably comprises an appropriate seal 4 to ensure that it properly seats and seals into stem release body 2. A tapered or otherwise appropriately shaped area, such as point 34, may be located at the insertion end of handle 8, for proper connection with the valve, as will be explained. Handle 10 is preferably permanently connected to body 2 for improved strength, but may be removable, for example for ease of transport. In addition, more than two handles may be provided for improved leverage.

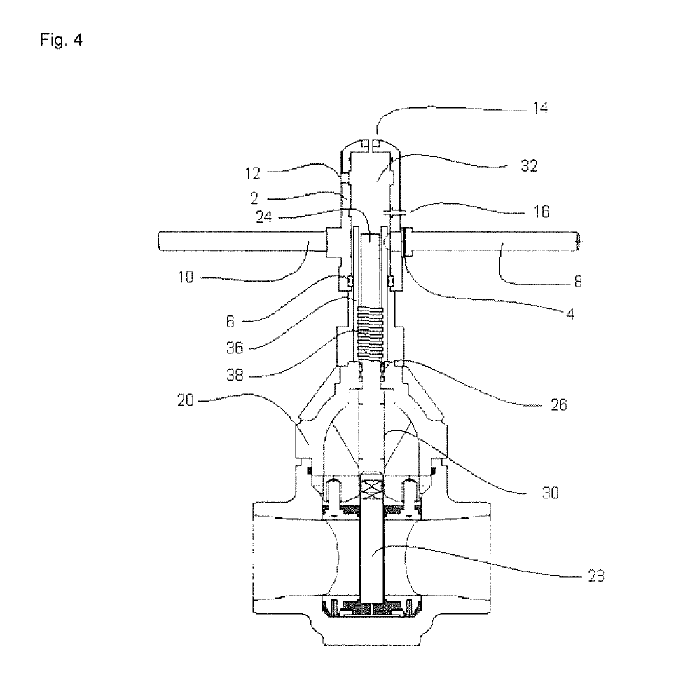

Body 2 is preferably at least partially hollow, having a compartment 32 connected to an opening preferably comprising a second seal 6, to ensure that the body 2 properly seats and seals on the stem actuator of a valve, as will be explained. Body 2 is intended to contain fluid in compartment 32 (shown only in FIG. 4), and therefore contains a fill port 12 to pass fluid into compartment 32, as well as at least one high pressure port 14, also fluidly connected to compartment 32. Alternatively or in addition, a high pressure port 16 may be located on a side of the body 2, also in fluid communication with compartment 32.

Referring now to FIG. 4, in operation the release tool is placed upon the seized valve assembly 20, from which the control handle 22 (not shown) has been removed. The body 2 is locked into place by inserting the locking handle 8 into the body 2 such that seal 4 seals the body 2 and the point 34 is seated in the stem actuator sleeve 36 or another appropriate portion of the valve assembly 20. Seal 6 ensures that the lower end of the release tool body 2 is sealed around stem actuator sleeve 36.

Compartment 32 is filled with a penetrating fluid via the fill port 12. The fill port 12 is then sealed by any appropriate method, such as a plug (not shown). Compartment 32 is pressurized by adding high-pressure fluid through the high-pressure side port 16. Further fluid is introduced via the top high-pressure port 14, raising the pressure in compartment 32 to a predetermined pressure.

During operation, a pressure drop in storage area 32 indicates that the penetrating fluid has passed through the clearance between the control stem 24 and stem actuator sleeve 36. This lubricates the stem actuator 38 and other problem areas of the valve stem 24, such as the gate valve slide 30. Once the penetrating fluid has begun to move through the valve 20, handles 8, 10 may be worked until the valve stem 24 rotates freely, indicating that the valve is no longer seized. The release tool may then be removed and the valve is put back into operation.

It will be understood that while the operation of the stem release tool has been described with respect to an exemplary gate valve, the tool may be applied to any valve having a valve stem and an appropriate configuration to receive the stem release tool and the pressurized penetrating fluid. In particular, while the stem has been shown as vertically oriented, the stem release tool of the present invention could be used to manipulate a valve that is oriented sideways, as pressure is used to force the penetrating fluid through the valve, rather than relying on gravity to carry the fluid into the valve.

In the foregoing description, exemplary modes for carrying out the invention in terms of examples have been described. However, the scope of the claims should not be limited by those examples, but should be given the broadest interpretation consistent with the description as a whole. The specification and drawings are, accordingly, to be regarded in an illustrative rather than a restrictive sense.

What is claimed is:

1. A tool for use in releasing a valve stem in a valve assembly, the tool comprising:
a body comprising a hollow compartment and an open end;
a first handle removably attached to said body, said first handle comprising a point to engage with said valve assembly;
a fill port in said body; and
at least one high-pressure port in said body;
wherein said fill port and said at least one high-pressure port are fluidly connected to said compartment to fill said compartment with a penetrating fluid and to pressurize said fluid within said compartment to force it towards said open end and into said valve assembly.

2. The tool of claim 1 further comprising a second handle protruding from said body.

3. The tool of claim 2 wherein said second handle is opposed to said first handle.

4. A method of freeing a valve stem in a valve assembly, comprising the steps of:
providing a stem release tool, said tool comprising:
a body comprising a hollow compartment and an open end;
a first handle removably attached to said body;
a fill port in said body; and
at least one high-pressure port in said body;
placing said open end on said valve assembly;
inserting said first handle into said body such that a point on said first handle engages said valve assembly;
filling said compartment with a penetrating fluid through said fill port;
pressurizing said compartment using said at least one high pressure port until said penetrating fluid penetrates said valve assembly; and
applying pressure to said first handle to manipulate said valve assembly through said stem release tool until said valve stem moves.

5. The method of claim 4 wherein said tool comprises a second handle attached to said body, the method further comprising the step of applying pressure to both of said handles.
